(19) United States
(12) Patent Application Publication
(10) Pub. No.: US 2026/0015943 A1
(43) Pub. Date: Jan. 15, 2026

(54) WIRE SCREEN PARTICLE FILTER FOR TURBOMACHINE AIRFOIL

(71) Applicant: GE Vernova Infrastructure Technology LLC, Greenville, SC (US)

(72) Inventors: Kathen Thomas Kotay, Greenville, SC (US); Frederic Woodrow Roberts, JR., Greenville, SC (US)

(21) Appl. No.: 19/335,773

(22) Filed: Sep. 22, 2025

Related U.S. Application Data
(63) Continuation of application No. 18/066,664, filed on Dec. 15, 2022.

(30) Foreign Application Priority Data
Dec. 20, 2021 (WO) PCT/US2021/073026

(51) Int. Cl. F01D 5/18

(52) U.S. Cl. CPC F01D 5/187; F05D 2260/607

(57) ABSTRACT

A filter for an airfoil of a vane of a turbomachine is disclosed. The filter includes a mounting member for mounting to an endwall of the vane. The mounting member has a first flow exit opening defined therethrough for fluid communication with a cooling circuit of the airfoil. A screen frame is coupled to the mounting member to support a wire screen around the first flow exit opening, and a first wire screen is positioned over the screen frame. The screen frame has an exterior shape supporting the wire screen in a manner incapable of having a horizontal surface regardless of a circumferential position of the airfoil around an axis of the turbomachine. A related turbine vane and turbine system are also provided.

### CROSS-REFERENCE TO RELATED APPLICATIONS

This application is a continuation of U.S. patent application Ser. No. 18/066,664, filed on Dec. 15, 2022, which claims priority pursuant to 35 U.S.C. § 119(a) to Patent Cooperation Treaty Application No. PCT/US2021/073026, filed Dec. 20, 2021, which application is incorporated herein by reference in its entirety.

### TECHNICAL FIELD

The disclosure relates generally to particle filters and, more particularly, to a wire screen filter for an airfoil of a turbine vane with a screen frame having an exterior shape supporting the wire screen in a manner incapable of having a horizontal surface regardless of a circumferential position of the airfoil around an axis of the turbomachine. A related turbine vane and turbine system are also provided.

### BACKGROUND

A wide variety of industrial machines use an air flow that needs to be cleaned of particles, for example, dust, dirt, or soot. One industrial machine that uses a cleaned air flow includes a turbine system, such as a gas turbine (GT) system. In a GT system, an air flow from a compressor is used for combustion purposes and for cooling purposes. For example, an air flow may be directed into cooling circuits in airfoils of the turbine vanes or blades of a GT system. Cooling circuits may prevent the airfoils from overheating from the hot combustion gases that pass over the vanes or blades. The cooling circuit typically includes a number of very small cooling passages that take complex paths through the airfoil. Particles in the cooling air can clog the cooling passages if not removed prior to the cooling air entering the cooling circuit. Current approaches employ various particle separators or collectors that are integral parts of the turbine vane or blade. Consequently, these separators or collectors cannot be retrofitted to older turbine vanes or blades, and they cannot be customized for certain vanes or blades.

### BRIEF DESCRIPTION

All aspects, examples, and features mentioned below can be combined in any technically possible way.

An aspect of the disclosure includes a filter for an airfoil of a vane of a turbomachine, the filter comprising: a mounting member for mounting to an endwall of the vane, the mounting member having a first flow exit opening defined therethrough for fluid communication with a cooling circuit of the airfoil; a screen frame coupled to the mounting member to support a wire screen around the first flow exit opening; and a first wire screen positioned over the screen frame, wherein the screen frame has an exterior shape supporting the wire screen in a manner incapable of having a horizontal surface regardless of a circumferential position of the airfoil around an axis of the turbomachine.

Another aspect of the disclosure includes any of the preceding aspects, and the mounting member includes a second flow exit opening defined therethrough for fluid communication with the cooling circuit of the airfoil, and further comprising a second wire screen positioned over the second flow exit opening.

Another aspect of the disclosure includes any of the preceding aspects, and the mounting member includes a metal plate shaped for sealed coupling with the endwall of the vane.

Another aspect of the disclosure includes any of the preceding aspects, and the exterior shape of the screen frame is that of an elongated trigonal pyramid.

Another aspect of the disclosure includes any of the preceding aspects, and the exterior shape of the screen frame is that of an elongated square pyramid.

Another aspect of the disclosure includes any of the preceding aspects, and the exterior shape of the screen frame is that of a half capsule.

Another aspect of the disclosure includes any of the preceding aspects, and the exterior shape of the screen frame is that of a frustum of a right circular cylinder.

Another aspect of the disclosure includes any of the preceding aspects, and the exterior shape of the screen frame is that of a frustum of a right square cylinder.

Another aspect of the disclosure includes any of the preceding aspects, and the exterior shape of the screen frame is that of a frustum of an elongated triangular cylinder.

Another aspect of the disclosure includes any of the preceding aspects, and the exterior shape of the screen frame is that of a frustum of an elongated polygon.

Another aspect of the disclosure includes any of the preceding aspects, and the first wire screen has openings in the range of 0.19-0.38 millimeters.

Another aspect includes a vane for a turbomachine, the vane comprising: an inner endwall; an outer endwall; an airfoil coupling the inner endwall and the outer endwall, the airfoil including a cooling circuit therein; and a filter for the airfoil, the filter including: a mounting member for mounting to at least one of the inner endwall and the outer endwall of the vane, the mounting member having a first flow exit opening defined therethrough for fluid communication with the cooling circuit of the airfoil; a screen frame coupled to the mounting member to support a wire screen around the first flow exit opening; and a first wire screen positioned over the screen frame, wherein the screen frame has an exterior shape supporting the wire screen in a manner incapable of having a horizontal surface regardless of a circumferential position of the airfoil around an axis of the turbomachine.

Another aspect of the disclosure includes any of the preceding aspects, and the mounting member includes a second flow exit opening defined therethrough for fluid communication with the cooling circuit of the airfoil, and further comprising a second wire screen positioned over the second flow exit opening.

Another aspect of the disclosure includes any of the preceding aspects, and the mounting member includes a metal plate shaped for sealed coupling with the respective inner endwall or outer endwall of the vane.

Another aspect of the disclosure includes any of the preceding aspects, and the exterior shape of the screen frame is that of an elongated trigonal pyramid.

Another aspect of the disclosure includes any of the preceding aspects, and the exterior shape of the screen frame is that of an elongated square pyramid.

Another aspect of the disclosure includes any of the preceding aspects, and the exterior shape of the screen frame is that of a half capsule.

Another aspect of the disclosure includes any of the preceding aspects, and the exterior shape of the screen frame is that of a frustum of a right circular cylinder.

Another aspect of the disclosure includes any of the preceding aspects, and the exterior shape of the screen frame is that of a frustum of an elongated polygon.

An aspect of the disclosure includes a turbine system, comprising: an engine core including a compressor, a combustor, and a turbine operatively coupled together, the turbine including a turbine stage having a plurality of vanes, each vane of the turbine stage including an inner endwall, an outer endwall, and an airfoil coupling the inner endwall and the outer endwall; and a filter for a respective airfoil of at least one vane of the turbine stage, the filter including: a mounting member for mounting to an endwall of the at least one vane, the mounting member having a first flow exit opening defined therethrough for fluid communication with the cooling circuit of the respective airfoil; a screen frame coupled to the mounting member to support a wire screen around the first flow exit opening; and a first wire screen positioned over the screen frame, wherein the screen frame has an exterior shape supporting the wire screen in a manner incapable of having a horizontal surface regardless of a circumferential position of the respective airfoil around an axis of the turbomachine.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a schematic view of an illustrative gas turbine system in which embodiments of the disclosure can be used;

FIG. 2 is a cross-section view of an illustrative turbine assembly with three turbine stages that may be used with the gas turbine system in FIG. 1;

FIG. 3 is a perspective view of a turbine vane including a filter that may be used with the turbine assembly of FIG. 2, according to embodiments of the disclosure;

FIG. 4A is an enlarged perspective view of a turbine vane including a filter without a wire screen thereover, according to embodiments of the disclosure;

FIG. 4B is an enlarged perspective view of a turbine vane including a filter with a wire screen thereover, according to embodiments of the disclosure;

FIG. 5A is an enlarged perspective view of a turbine vane including a filter without a wire screen thereover, according to another embodiment of the disclosure;

FIG. 5B is an enlarged perspective view of a turbine vane including a filter with a wire screen thereover, according to another embodiment of the disclosure;

FIG. 6 is a schematic perspective view of an exterior shape of a screen frame supporting a wire screen for a filter, according to embodiments of the disclosure;

FIG. 7 is a schematic perspective view of an exterior shape of a screen frame supporting a wire screen for a filter, according to embodiments of the disclosure;

FIG. 8 is a schematic perspective view of an exterior shape of a screen frame supporting a wire screen for a filter, according to embodiments of the disclosure;

FIG. 9 is a schematic perspective view of an exterior shape of a screen frame supporting a wire screen for a filter, according to embodiments of the disclosure;

FIG. 10 is a schematic perspective view of an exterior shape of a screen frame supporting a wire screen for a filter, according to embodiments of the disclosure;

FIG. 11 is a schematic perspective view of an exterior shape of a screen frame supporting a wire screen for a filter, according to embodiments of the disclosure;

FIG. 12 is a schematic perspective view of an exterior shape of a screen frame supporting a wire screen for a filter, according to embodiments of the disclosure;

FIG. 13 is a perspective view of a turbine vane including a filter, according to other embodiments of the disclosure; and

FIG. 14 is a perspective view of a turbine vane including a pair of filters, according to other embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current disclosure, it will become necessary to select certain terminology when referring to and describing relevant machine components within an industrial machine employing a filter such as a gas turbine system. To the extent possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the turbine or, for example, the flow of air through a filter. The term “downstream” corresponds to the direction of flow of the fluid, and the term “upstream” refers to the direction opposite to the flow (i.e., the direction from which the flow originates). The terms “forward” and “aft,” without any further specificity, refer to directions, with “forward” referring to the front or compressor end of the turbomachine, and “aft” referring to the rearward section of the turbomachine.

It is often required to describe parts that are disposed at different radial positions with regard to a center axis. The term “radial” refers to movement or position perpendicular to an axis. For example, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis. Finally, the term “circumferential” refers to movement or position around an axis. It will be appreciated that such terms may be applied in relation to the center axis of the gas turbine.

In addition, several descriptive terms may be used regularly herein, as described below. The terms “first”, “second”, and “third” may be used interchangeably to distinguish one component from another and are not intended to signify location or importance of the individual components.

The terminology used herein is for the purpose of describing particular embodiments only and is not intended to be limiting of the disclosure. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. “Optional” or “optionally” means that the subsequently described event or circumstance may or may not occur or that the subsequently describe component or element may or may not be present, and that the description includes instances where the event occurs or the component is present and instances where it does not or is not present.

Where an element or layer is referred to as being “on,” “engaged to,” “connected to” or “coupled to” another element or layer, it may be directly on, engaged to, connected to, or coupled to the other element or layer, or intervening elements or layers may be present. In contrast, when an element is referred to as being “directly on,” “directly engaged to,” “directly connected to” or “directly coupled to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As indicated above, the disclosure provides a filter for an airfoil of a turbine vane of a turbomachine. The filter includes a mounting member for mounting to an end of the airfoil. The mounting member has a first flow exit opening defined therethrough for fluid communication with a cooling circuit of the airfoil. A screen frame is coupled to the mounting member to support a wire screen around the first flow exit opening, and a first wire screen is positioned over the screen frame. The screen frame has an exterior shape supporting the wire screen in a manner incapable of having a horizontal surface regardless of a circumferential position of the airfoil around an axis of the turbomachine. The screen frame also increases surface area of the wire screen to improve capacity and efficacy. A related turbine vane and turbine system are also provided. The filter separates particles from the gas flow that could enter and potentially clog or hinder performance of the cooling circuit in the airfoil. The filter allows particle separation without a significant pressure drop that would negatively impact subsequent use of the compressed gas flow, for example, for cooling downstream of the filter in the cooling circuit of a turbine vane. The filter can be used on any turbine vane regardless of its eventual position in a gas turbine, such as a turbine section, a compressor section, etc.

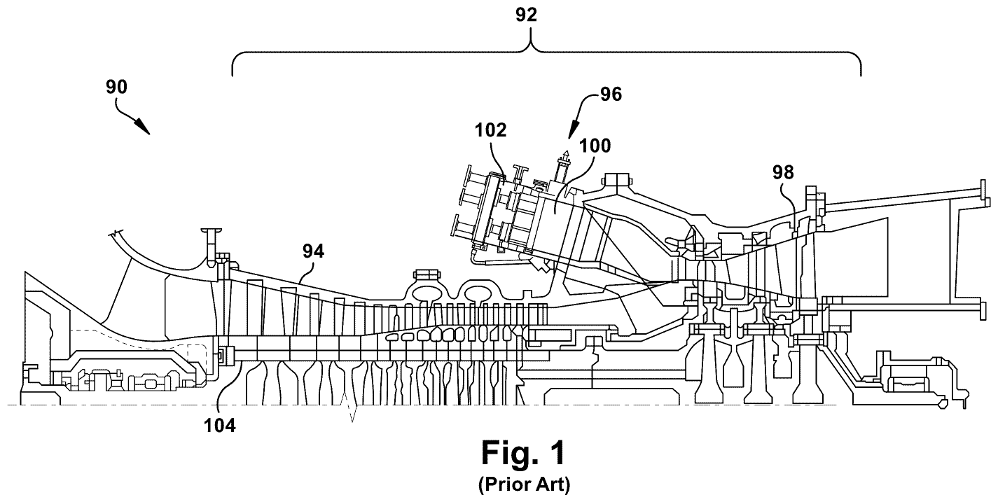

FIG. 1 is a schematic illustration of an exemplary turbomachine 90 in the form of a gas turbine (GT) system. Turbomachine 90 includes an engine core 92 including a compressor 94, a combustor 96, and a turbine 98 operatively coupled together. Combustor 96 includes a combustion region 100 and a fuel nozzle assembly 102. Turbomachine 90 may also include a common compressor/turbine shaft 104 (sometimes referred to as rotor 104). In one embodiment, turbomachine 90 is a 7HA.03 engine, commercially available from General Electric Company, Greenville, S.C. The applications of the present disclosure are not limited to any one particular GT system and may be used in connection with other turbine systems including, for example, the other HA, F, B, LM, GT, TM and E-class engine models of General Electric Company, as well as engine models of other companies. As noted, a filter, as described herein, can also be used on a variety of industrial machines other than a gas turbine system, e.g., a compressor, jet engine, etc. In a gas turbine system, the cooling medium being cleaned by the filter is air, but the cooling medium may not be air in other industrial machines.

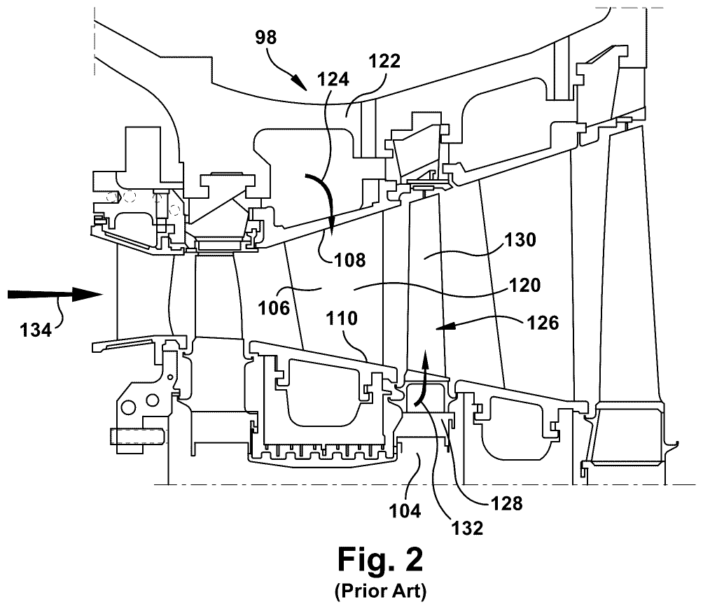

FIG. 2 is cross-sectional view of an illustrative turbine 98 with three stages of blades and nozzles that may be used with turbomachine 90 in FIG. 1. Turbine 98 may include more or fewer stages than shown. Turbine 98 includes a plurality of vanes 106 (into and out of page) arranged in a turbine stage. Each vane 106 includes a (radially) outer endwall 108, a (radially) inner endwall 110, and an airfoil 120 coupling outer endwall 108 and inner endwall 110. Vanes 106 are held in a casing 122 of turbine 98 by outer endwall 108. As understood, a compressed gas (air) flow 124 passes through casing 122 from compressor 94 (FIG. 1) and enters cooling circuits (not shown in FIG. 2) in vanes 106 to cool the vanes. Turbine 98 also includes a plurality of rotating blades 126 (into and out of page), which, with the adjacent upstream vanes 106, define a turbine stage. Each blade 126 includes a base 128 coupled to rotor 104 and an airfoil 130 extending from base 128. As understood, a compressed air flow 132 passes through base 128 from compressor 94 (FIG. 1) and enters cooling circuits (not shown in FIG. 2) in blades 126 to cool the blades.

Referring to FIGS. 1 and 2, in operation, air flows through compressor 94, and compressed air is supplied to combustor 96. Specifically, the compressed air is supplied to fuel nozzle assembly 102 that is integral to combustor 96. Fuel nozzle assembly 102 is in flow communication with combustion region 100. Fuel nozzle assembly 102 is also in flow communication with a fuel source (not shown in FIG. 1) and channels fuel and air to combustion region 100. Combustor 96 ignites and combusts fuel to produce combustion gases. Combustor 96 is in flow communication with turbine 98 in which gas stream thermal energy is converted to mechanical rotational energy through a hot gas path 134 of turbine 98. Turbine 98 is rotatably coupled to and drives rotor 104. Combustion gases directed by vanes 106 turn blades 126 and rotor 104. Compressor 94 may also be rotatably coupled to shaft 104. In the illustrative embodiment, there is a plurality of combustors 96 and fuel nozzle assemblies 102.

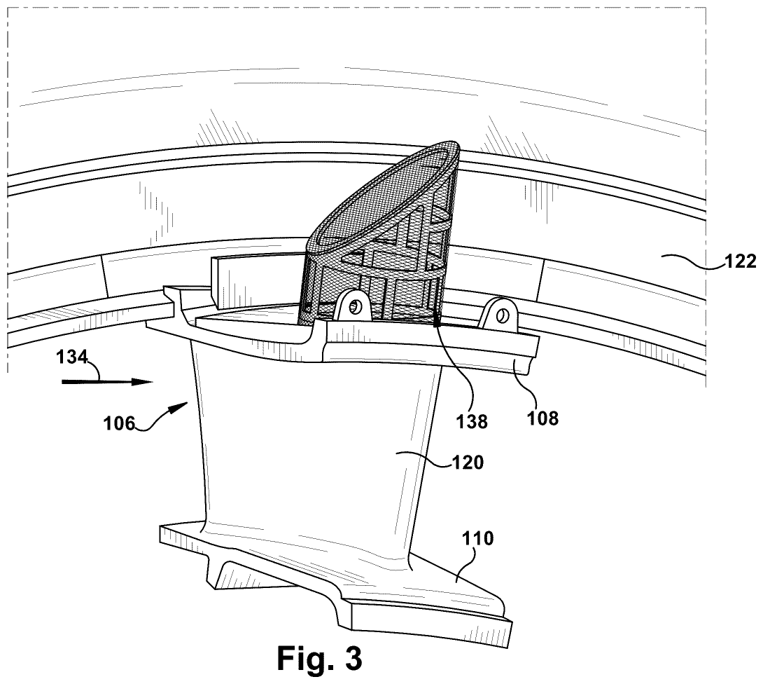

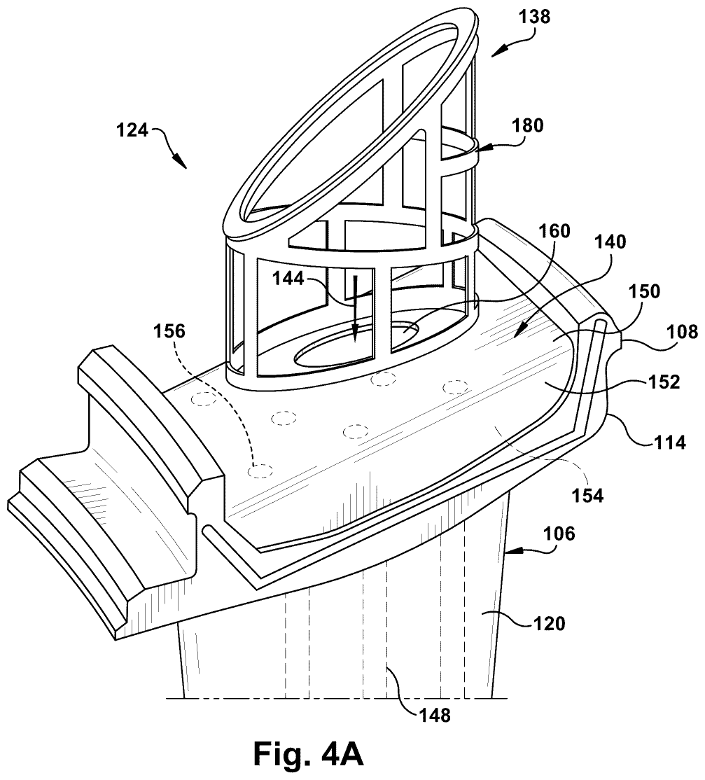

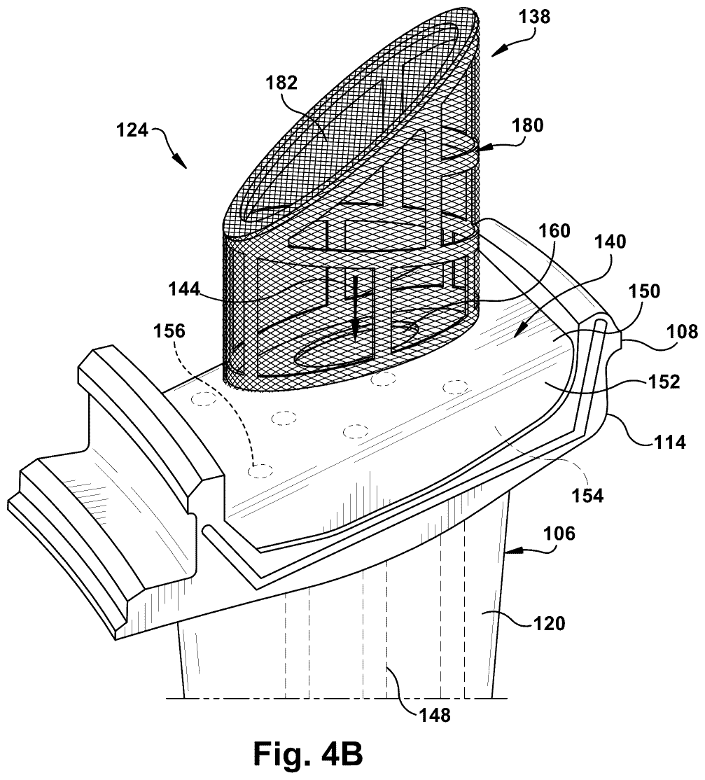

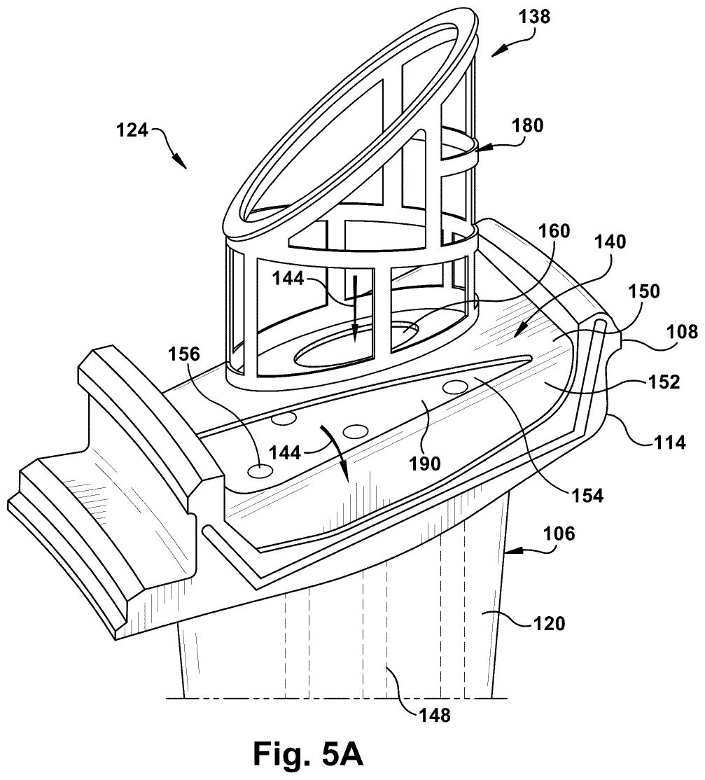

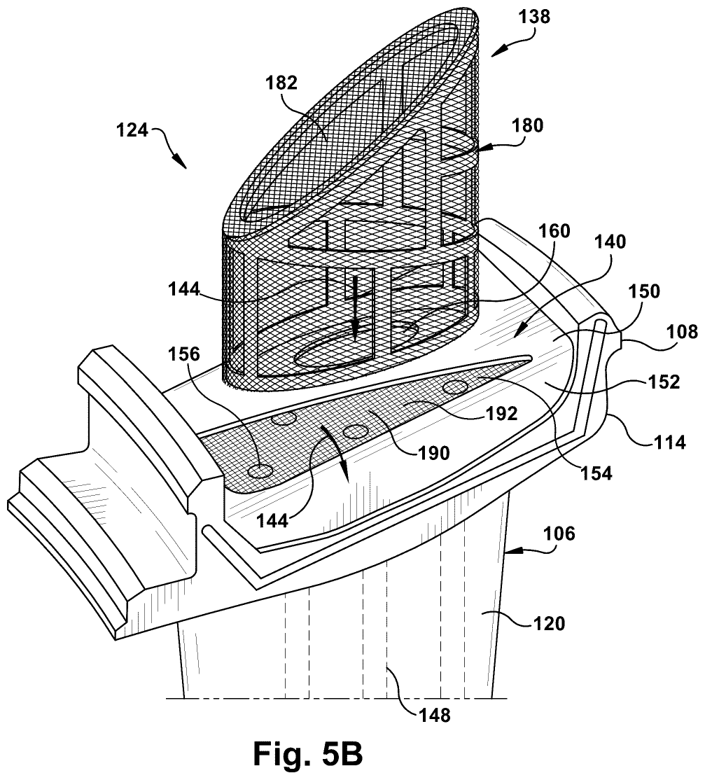

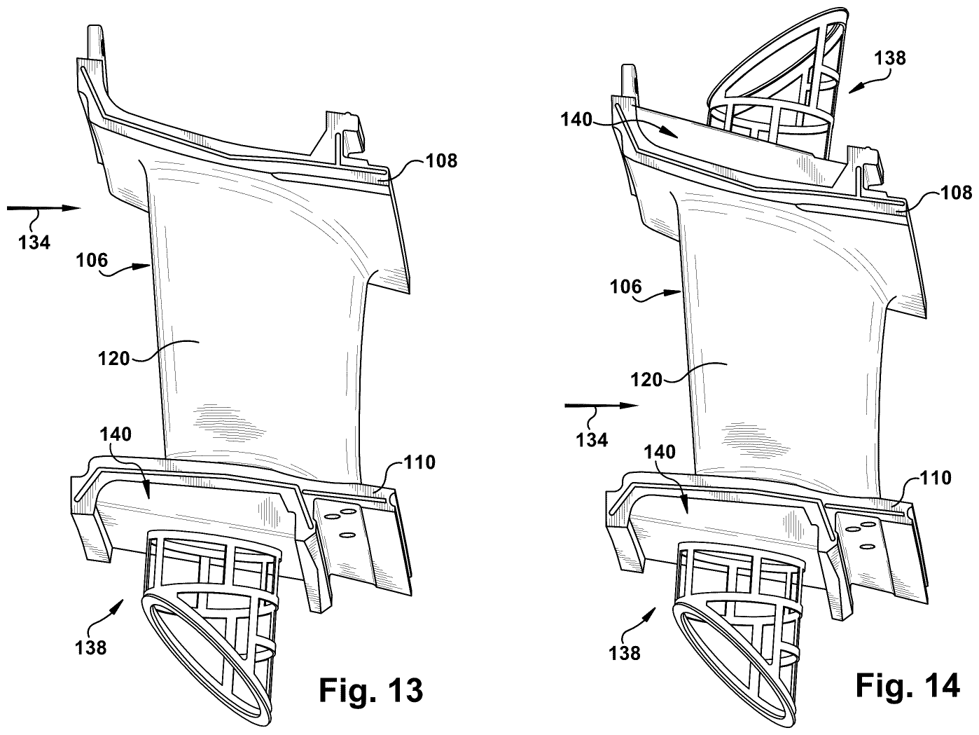

FIG. 3 shows a perspective view of a single illustrative turbine vane 106 including a filter 138 on outer endwall 108 thereof. In certain embodiments, filter 138 may be mounted to one of inner endwall 110 (see FIG. 13) and outer endwall 108 (as shown) of one or more vanes 106 in turbomachine 90. In another embodiment, shown in FIG. 14, a filter 138 may be mounted to both inner endwall 110 and outer endwall 108 of one or more vanes 106 in turbomachine 90. For description purposes, FIGS. 4A-B show enlarged perspective views of filter 138 on outer endwall 108 of turbine vane 106, according to one embodiment of the disclosure; and FIGS. 5A-B shows an enlarged perspective view of filter 138 on outer endwall 108, according to an alternative embodiment of the disclosure. FIGS. 4A and 5A show the filters without a wire screen thereon, and FIGS. 4B and 5B show the filters with the wire screens thereon.

As shown in FIGS. 4A-B and 5A-B, filter 138 for airfoil 120 of turbine vane 106 may include a mounting member 140 for mounting to an end of airfoil 120. Mounting member 140 may include any structure capable of fluidly coupling to, for example, outer endwall 108 such that a clean gas flow 144 (FIG. 4) (e.g., air) exiting filter 138 is fluidly communicated to a subsequent use, such as within a cooling circuit 148 in airfoil 120 of turbine vane 106. In the non-limiting example shown, mounting member 140 includes a metal plate 150 (e.g., a plate element) including any number of coupling walls 152 for sealed coupling with an end of turbine vane 106, such as outer endwall 108. Mounting member 140 may thus form a manifold 154 with outer endwall 108.

Mounting member 140 can take a variety of different forms depending on the structure to which filter 138 is coupled. Mounting member 140 may include a first flow exit opening 160 defined therethrough, e.g., through wall(s) of metal plate 150 of mounting member 140. First flow exit opening 160 is in fluid communication with, for example, cooling circuit 148 via one or more openings 156 in airfoil 120 (and perhaps outer endwall 108) via manifold 154. First flow exit opening 160 is also in fluid communication with an interior of a screen frame 180 and a first wire screen 182. In this manner, clean gas flow 144 (air) that has passed through first wire screen 182 exits through first flow exit opening 160 and enters at least cooling circuit 148 in airfoil 120. Cooling circuit 148 in airfoil 120 and/or outer endwall 108 can take any now known or later developed form, but typically includes one or more openings 156 in outer endwall 108 that are in fluid communication with manifold 154 so clean gas flow 144 can enter openings 156.

Screen frame 180 of filter 138 is coupled to mounting member 140, e.g., with fasteners or welds, to support a wire screen around first flow exit opening 160. As shown in FIGS. 4B and 5B, filter 138 also includes first wire screen 182 positioned over screen frame 180. As understood in the art, turbine vanes 106 of which airfoil 120 is part are mounted in a spaced circumferential manner around an axis, e.g., of rotor 104 (FIGS. 1-2) of turbomachine 90 (FIGS. 1-2). The plurality of turbine vanes 106 in a given axial position of rotor 104 create a given axial stage of vanes for, for example, turbine section 98. In this manner, a turbine vane 106 may be located at any radial angle relative to the axis of rotor 104. It has been discovered that when a particle filter for airfoils 120 includes horizontal surfaces, the horizontal surfaces are prone to clogging. Clogging hinders or prevents a cooling flow from passing therethrough for cooling circuit 148 in airfoil 120.

To address this challenge, as shown in FIGS. 4B and 5B, screen frame 180 has an exterior shape supporting first wire screen 182 in a manner incapable of having a horizontal surface regardless of a circumferential position of airfoil 120 around an axis of turbomachine 90. As used herein, “horizontal surface” means within +/−5° of horizontal. Screen frame 180 may include any metal structural framing capable of withstanding the environment in which used. Screen frame 180 may include any shape or form of structural framing, e.g., elongate members, curved straps, beams, collars, etc., to form the desired exterior shape with sufficient rigidity to withstand the operational environment. Screen frame 180 also increases the surface area of wire screen 182 to improve capacity and efficacy of filtering. Screen frame 180 however has a radial height that is sufficiently small to fit within the available radial space adjacent endwall(s) 108, 110. In certain embodiments, shown in FIGS. 4A-B and 5A-B, the exterior shape of screen frame 180 is that of a frustum of a right circular cylinder. That is, it has a shape of a cylinder having a slanted top. A surface of screen frame 180, where coupled to mounting member 140, can have any desired shape to ensure no leakage of a gas flow occurs.

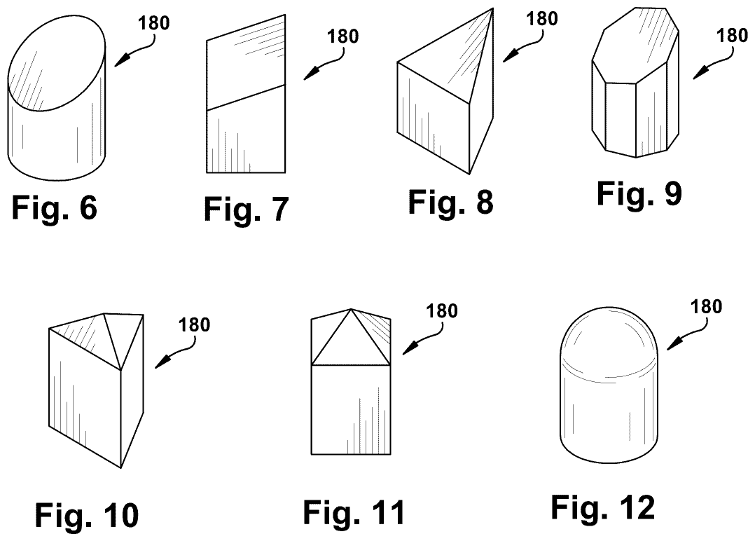

Screen frame 180 can have a variety of shapes. FIG. 6 show a schematic perspective view of the exterior shape of screen frame 180 as in FIGS. 4A-B and 5A-B. FIGS. 7-12 show schematic perspective views of an exterior shape of screen frame 180 according to a variety of alternative embodiments of the disclosure. In FIG. 7, the exterior shape of screen frame 180 is that of a frustum of a right square cylinder. In FIG. 8, the exterior shape of screen frame 180 is that of a frustum of an elongated triangular cylinder. In FIG. 9, the exterior shape of screen frame 180 is that of a frustum of an elongated polygon, e.g., an octagonal cylinder. In FIG. 10, the exterior shape of screen frame 180 is that of an elongated trigonal pyramid, i.e., etripy. In FIG. 11, the exterior shape of screen frame 180 is that of an elongated square pyramid, i.e., esquipy. In FIG. 12, the exterior shape of screen frame 180 is that of a half capsule, i.e., a cylinder having a hemispherical end. While examples of exterior shapes of screen frame 180 have been provided, other shapes may also be used.

In FIGS. 4A-B, mounting member 140 includes metal plate (150, 152), which is generally solid other than where flow exit opening 160 is present. Returning to FIGS. 5A-B, in certain embodiments, mounting member 140 may include a second flow exit opening 190 defined therethrough for fluid communication with cooling circuit 148 of airfoil 120. Here, filter 138 may include a second wire screen 192 positioned over second flow exit opening 190. No screen frame is necessary for second wire screen 192. Second flow exit opening 190 may be provided, for example, where mounting member 140 cannot be present, for example, because a mounting structure (not shown) for vane 106 requires space. Second flow exit opening 190 allows more clean gas flow 144 through. As can be observed, depending on a location of airfoil 120 in turbomachine 90, second wire screen 192 may be in a horizontal position, e.g., on lower airfoils that extend radially upward.

Wire screens 182, 192 may be coupled to screen frame 180 and/or mounting member 140 in any manner, e.g., fasteners or welding. First wire screen 182 may include one or more wire screen elements, depending on the shape of screen frame 180. First wire screen 182 and second wire screen 192 may have openings having a size commensurate with the type and size of particles to be captured thereby, e.g., rust particles. In one example, for a turbomachine 90 (FIG. 1), first wire screen 182 and second wire screen 192 may have openings in the range of 0.19-0.38 millimeters (widest dimension). In another example, for a turbomachine 90, first wire screen 182 and second wire screen 192 may have openings approximately 0.23 millimeters in size.

As previously described relative to FIGS. 4A-B and 5A-B, in one embodiment, filter 138 may be operatively mounted to outer endwall 108 of turbine vane 106 by mounting member 140. As shown in FIG. 13, in another embodiment, filter 138 may be operatively mounted to inner endwall 110 of turbine vane 106 by another similar mounting member 140. Flow exit opening 160 is defined in wall of metal plate 150 of mounting member 140 and is in fluid communication with cooling circuit 148 in an interior of airfoil 120 of turbine vane 106. As shown in FIG. 14, in another embodiment, a filter 138 may be operatively mounted to each of outer endwall 108 and inner endwall 110 of turbine vane 106 by a respective mounting member 140. Flow exit opening 160 of each filter 138 is defined in wall of metal plate 150 of mounting member 140 thereof and is in fluid communication with cooling circuit 148 in an interior of airfoil 120 of turbine vane 106. Clean gas flow 144 (FIGS. 4A-B, 5A-B) is delivered to both ends of airfoil 120 of turbine vane 106. The FIGS. 13 and 14 embodiments may employ either or both of the FIGS. 4A-B and/or 5A-B versions of filter 138.

In operation, compressed gas flow 124 (FIGS. 2, 4A-B, 5A-B), such as air from compressor 94 (FIG. 1), passes through wire screen(s) 182, 192 of filter 138. Gas flow 124 includes particles that are too large for efficient use in, for example, cooling circuit 148 of turbine vane 106, and that need to be removed. Gas flow 124 passes through first wire screen 182 and passes through first flow exit opening 160 to cooling circuit 148 in airfoil 120. First wire screen 182 removes any particles larger than the screen opening size. Where provided, as shown in FIG. 5B, gas flow 124 also may pass through second wire screen 192 and pass through second flow exit opening 190 to cooling circuit 148 in airfoil 120. Particles in gas flow 124 are removed by wire screen(s) 182, 192. Clean gas flow 144 (FIGS. 4A-B and 5A-B) exits through flow exit opening(s) 160, 190 into, for example, cooling circuit 148 in airfoil 120 of turbine vane 106.

Screen frame 180 and wire screens 182, 192 can be made of any material capable of withstanding the environment in which employed. Screen frame 180 may be manufactured using any now known or later developed technology. Advantageously, screen frame 180 and/or wire screens 182, 192 can be additively manufactured, e.g., using direct metal laser melting (DMLM) techniques.

Embodiments of the disclosure provide a filter 138 that minimizes contaminants and that can reduce maintenance costs, extend the life, and/or increase reliability and durability of, for example, a turbine vane 106. Filter 138 can also advantageously be readily retrofitted to older vanes to extend the life thereof. Filter 138 can be positioned on any turbine vane 106 regardless of its eventual location in a turbine system. The size of filter 138 is such that it fits into tight spacing in many industrial machines such as, but not limited to, turbomachine 90.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

What is claimed is:

1. A filter for an airfoil of a vane of a turbomachine, the filter comprising:
a mounting member for mounting to an endwall of the vane, the mounting member having a first flow exit opening defined therethrough for fluid communication with a cooling circuit of the airfoil;
a screen frame coupled to the mounting member to support a wire screen around the first flow exit opening; and
a first wire screen positioned over the screen frame,
wherein the screen frame has an exterior shape supporting the wire screen in a manner incapable of having a horizontal surface regardless of a circumferential position of the airfoil around an axis of the turbomachine.

2. The filter of claim 1, wherein the mounting member includes a second flow exit opening defined therethrough for fluid communication with the cooling circuit of the airfoil, and further comprising a second wire screen positioned over the second flow exit opening.

3. The filter of claim 1, wherein the mounting member includes a metal plate shaped for sealed coupling with the endwall of the vane.

4. The filter of claim 1, wherein the exterior shape of the screen frame is that of an elongated trigonal pyramid.

5. The filter of claim 1, wherein the exterior shape of the screen frame is that of an elongated square pyramid.

6. The filter of claim 1, wherein the exterior shape of the screen frame is that of a half capsule.

7. The filter of claim 1, wherein the exterior shape of the screen frame is that of a frustum of a right circular cylinder.

8. The filter of claim 1, wherein the exterior shape of the screen frame is that of a frustum of a right square cylinder.

9. The filter of claim 1, wherein the exterior shape of the screen frame is that of a frustum of an elongated triangular cylinder.

10. The filter of claim 1, wherein the exterior shape of the screen frame is that of a frustum of an elongated polygon.

11. The filter of claim 1, wherein the first wire screen has openings in a range of 0.19-0.38 millimeters.

12. A vane for a turbomachine, the vane comprising:
an inner endwall;
an outer endwall;
an airfoil coupling the inner endwall and the outer endwall, the airfoil including a cooling circuit therein; and
a filter for the airfoil, the filter including:
a mounting member for mounting to at least one of the inner endwall and the outer endwall of the vane, the mounting member having a first flow exit opening defined therethrough for fluid communication with the cooling circuit of the airfoil;
a screen frame coupled to the mounting member to support a wire screen around the first flow exit opening; and
a first wire screen positioned over the screen frame,
wherein the screen frame has an exterior shape supporting the wire screen in a manner incapable of having a horizontal surface regardless of a circumferential position of the airfoil around an axis of the turbomachine.

13. The vane of claim 12, wherein the mounting member includes a second flow exit opening defined therethrough for fluid communication with the cooling circuit of the airfoil, and further comprising a second wire screen positioned over the second flow exit opening.

14. The vane of claim 12, wherein the mounting member includes a metal plate shaped for sealed coupling with a respective inner endwall or outer endwall of the vane.

15. The vane of claim 12, wherein the exterior shape of the screen frame is that of an elongated trigonal pyramid.

16. The vane of claim 12, wherein the exterior shape of the screen frame is that of an elongated square pyramid.

17. The vane of claim 12, wherein the exterior shape of the screen frame is that of a half capsule.

18. The vane of claim 12, wherein the exterior shape of the screen frame is that of a frustum of a right circular cylinder.

19. The vane of claim 12, wherein the exterior shape of the screen frame is that of a frustum of an elongated polygon.

20. A turbine system, comprising:
an engine core including a compressor, a combustor, and a turbine operatively coupled together, the turbine including a turbine stage having a plurality of vanes, each vane of the turbine stage including an inner endwall, an outer endwall, and an airfoil coupling the inner endwall and the outer endwall; and
a filter for a respective airfoil of at least one vane of the turbine stage, the filter including:
a mounting member for mounting to an endwall of the at least one vane, the mounting member having a first flow exit opening defined therethrough for fluid communication with the cooling circuit of the respective airfoil;
a screen frame coupled to the mounting member to support a wire screen around the first flow exit opening; and
a first wire screen positioned over the screen frame,
wherein the screen frame has an exterior shape supporting the wire screen in a manner incapable of having a horizontal surface regardless of a circumferential position of the respective airfoil around an axis of the turbomachine.
